(19) United States
(12) Patent Application Publication
(10) Pub. No.: US 2006/0070064 A1
(43) Pub. Date: Mar. 30, 2006

(54) Computer apparatus on which download board can be mounted

(75) Inventor: Katsuya Sasahara, Izu-shi (JP)

Correspondence Address: FOLEY AND LARDNER LLP;SUITE 500, 3000 K STREET NW, WASHINGTON, DC, 20007, US

(73) Assignee: TOSHIBA TEC KABUSHIKI KAISHA

(21) Appl. No.: 11/008,149

(22) Filed: Dec. 10, 2004

(30) Foreign Application Priority Data
Sep. 28, 2004 (JP) 2004-281783

(51) Int. Cl. G06F 9/445

(52) U.S. Cl. 717/178; 717/168

(57) ABSTRACT

When a CPU senses a connect signal output from a signal generating unit to detect connection between a download board and a socket, the CPU assigns a control program, which is specified by a signal for specifying a sector CS0 area switched to be output from a switching circuit and stored in a second flash ROM, to the sector CS0 area of the CPU to execute the control program, and the CPU downloads the control program stored in the second flash ROM into a first flash ROM.

### CROSS-REFERENCE TO RELATED APPLICATIONS

This application is based upon and claims the benefit of priority from prior Japanese Patent Application No. 2004-281783, filed Sep. 28, 2004, the entire contents of which are incorporated herein by reference.

### BACKGROUND OF THE INVENTION

1. Field of the Invention

The present invention relates to a computer apparatus on which a download board can be mounted.

2. Description of the Related Art

For example, in an image forming apparatus, a flash ROM (Read Only Memory) in which a control program is stored is mounted on a target board. The control program stored in the flash ROM is executed by a CPU.

Sometimes it is necessary to upgrade a version of the control program stored in the flash ROM.

In this case, usually the control program is downloaded to the CPU (Central Processing Unit) memory through serial communication. However, in the download through the serial communication, there are problems that communication speed is slow and transfer error is generated to result in failure of the download.

There is known the image forming apparatus in which the upgraded control program is downloaded from a program stored in an IC card (see Jpn. Pat. Appln. KOKAI Publication No. 2000-105703).

In the image forming apparatus described in Jpn. Pat. Appln. KOKAI Publication No. 2000-105703, the program stored in the IC card is downloaded when a specific switch is turned on and connection of the IC card is sensed.

### BRIEF SUMMARY OF THE INVENTION

An object of the invention is to provide the computer apparatus on which the download board being able to rapidly and simply download a control program can be mounted.

According to an aspect of the invention, a computer apparatus on which a download board can be mounted, comprising: a first flash ROM which stores a control program; a CPU which executes the control program; a socket which the download board can be inserted into and removed from, a second flash ROM being mounted on the download board, the control program being stored in the second flash ROM; a system board on which the socket is mounted; a signal generating unit configured to output a connect signal having a specific logic level when the download board is connected to the socket; and a switching circuit configured to switch a signal for specifying a sector CS0 area of the CPU and a signal for specifying a sector CS1 area of the CPU according to a status of the connect signal, the signal for specifying the sector CS0 area being output from the CPU according to the connect signal output from the signal generating unit, the sector CS0 area being used for a boot, wherein, when the CPU senses the connect signal output from the signal generating unit to detect connection between the download board and the socket, the CPU assigns the control program, which is specified by the signal for specifying the sector CS0 area output from the switching circuit and stored in the second flash ROM, to the sector CS0 area of the CPU to execute the control program, and the CPU downloads the control program stored in the second flash ROM to the first flash ROM.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWINGS

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a block diagram showing a computer apparatus according to an embodiment of the invention, on which a download board can be mounted;

FIG. 2 shows a memory map of a flash ROM according to the embodiment;

FIG. 3A shows a memory map of a CPU when the download board is not connected and FIG. 3B shows a memory map of the CPU when the download board is connected;

FIG. 4 is a flowchart showing control of a CPU according to the embodiment; and

FIG. 5 is a side view of an image forming apparatus having a finisher.

### DETAILED DESCRIPTION OF THE INVENTION

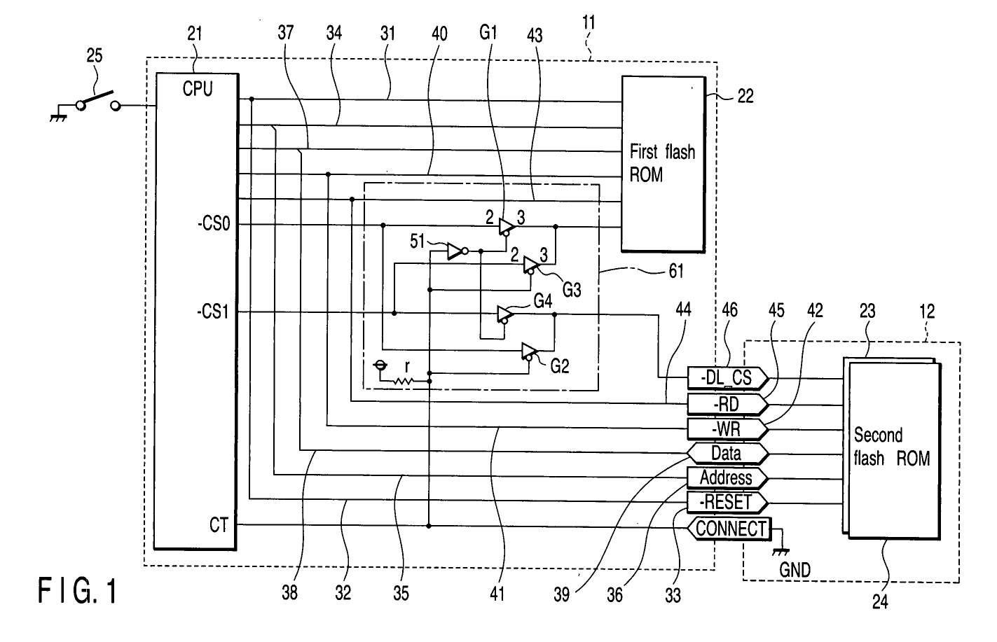

Referring to the accompanying drawings, a preferred embodiment of the invention will be described below. In FIG. 1, the reference numeral 11 represents a target system board and the reference numeral 12 represents a download board which can be mounted on the target system board 11.

A CPU (Central Processing Unit) 21 and a first flash ROM (read-only memory) 22 are mounted on the target system board 11. Various control programs are stored in the first flash ROM 22.

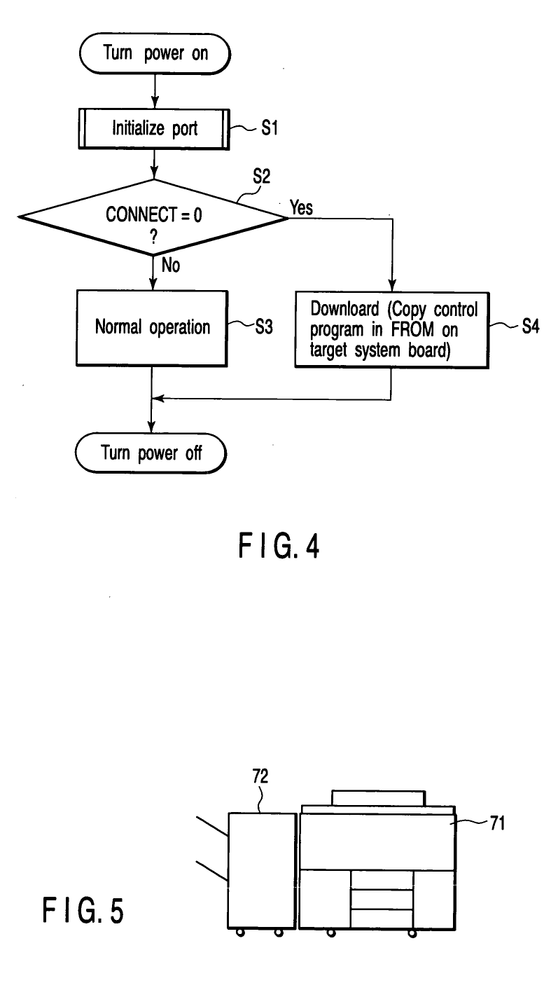

The CPU 21 includes a control program for controlling a flowchart shown in FIG. 4.

A socket 23 which enables the download board 12 to be inserted and removed is mounted on the target system board 11. A second flash ROM 24 is mounted on the download board 12. For example, the revised control program (also including IPL) is stored in the second flash ROM 24.

An operation signal of a power switch 25 is input to the CPU 21.

The CPU 21 outputs a reset signal (−RESET) to the first flash ROM 22 through a line 31, and the CPU 21 is connected to a reset terminal 33 of the socket 23 through a line 32.

The CPU 21 outputs an address signal to the first flash ROM 22 through an address bus 34, and the CPU 21 is connected to an address terminal 36 of the socket 23 through an address bus 35.

The CPU 21 outputs a data signal to the first flash ROM 22 through a data line 37, and the CPU 21 is connected to a data terminal 39 of the socket 23 through a data line 38.

The CPU 21 outputs a write signal (−WR) to the first flash ROM 22 through a line 40, and the CPU 21 is connected to a write terminal 42 of the socket 23 through a line 41.

The CPU 21 outputs a read signal (−RD) to the first flash ROM 22 through a line 43, and the CPU 21 is connected to a read terminal 45 of the socket 23 through a line 44.

A chip selecting terminal (−CS0) of the CPU 21 is connected to the first flash ROM 22 through a gate G1, and the CPU 21 is connected to a chip selecting terminal 46 of the socket 23 through a gate G2.

A chip selecting terminal (−CS1) of the CPU 21 is connected to the first flash ROM 22 through a gate G3, and the CPU 21 is connected to the chip selecting terminal 46 of the socket 23 through a gate G4.

When the download board 12 is inserted into the socket 23, a CONNECT terminal (specific signal generating unit) of the download board 12 is grounded. At this point, an L-level signal is output as a ground level. When the download board 12 is not inserted into the socket 23, an H-level signal is output as a CONNECT signal.

The CONNECT terminal is connected to a connecting terminal CT of the CPU 21, the CONNECT terminal outputs a gate signal to the gate G1 through an inverter 51, the CONNECT terminal outputs the gate signal to the gate G3, and the CONNECT terminal outputs the gate signal to the gate G2.

The inverter 51 outputs the gate signal to the gate G4.

When the gate signal is input to each of the gates G1 to G4, each of the gates G1 to G4 is opened.

An input side of the inverter 51 and gates of the gates G2 and G3 are connected to a power supply Vcc through a pull-up resistor r.

A switching circuit 61 is formed by the power supply Vcc, the pull-up resistor r, gates G1 to G4, and the inverter 51.

When the download board 12 is inserted into the socket 23, the CONNECT terminal (CONNECT signal) becomes the L-level. Therefore, the gates G2 and G3 are opened.

When the download board 12 is not inserted into the socket 23, the CONNECT terminal (CONNECT signal) becomes the H-level. Therefore, the gates G1 and G4 are opened.

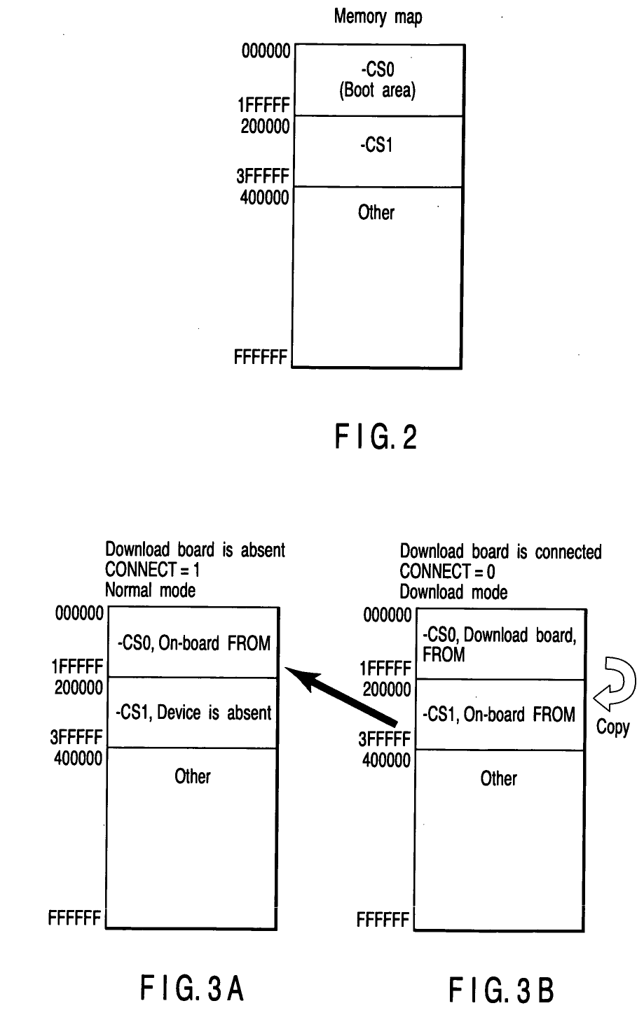

Then, referring to FIG. 2, a memory map of the CPU 21 will be described. As shown in FIG. 2, the memory map of the CPU 21 is formed by a boot area (−CS0) including an address of 000000 to an address of 1FFFFF, a second sector (−CS1) including an address of 200000 to an address of 3FFFFF, and other areas including an address of 400000 to an address of FFFFFF.

The operation of the embodiment of the invention, which has the above configuration, will be described below. When the power switch 25 is turned on, the CPU 21 executes a process of a flowchart of FIG. 4 stored in the ROM 21 or the ROM 24.

The CPU 21 initializes a port (Step S1). Then, the CPU 21 decides whether the CONNECT signal is 0 (L-level) or not (Step S2). As described above, the CONNECT signal becomes “0” (L-level) when the download board 12 is inserted into the socket 23, and the CONNECT signal becomes “1” (H-level) when the download board 12 is not inserted into the socket 23.

When the download board 12 is not inserted into the socket 23, the CPU 21 decides “NO” in the decision of Step S2, and the normal operation is performed (Step S3). When the download board 12 is not inserted into the socket 23, the gates G1 and G4 are opened, which allows a chip selecting signal (−CS0) output from the CPU 21 to be output to the first flash ROM 22 through the gate G1. Therefore, the control program stored in the first flash ROM 22 is assigned to the CS0 area of the CPU 21 and executed (see FIG. 3A). In this case, “NO” is judged in Step S2 and then a normal operation is executed.

On the other hand, when the download board 12 is inserted into the socket 23, the gates G2 and G3 are opened, which allows the chip selecting signal (−CS0) output from the CPU 21 to be output to the second flash ROM 24 mounted on the target system board 12 through the gate G2.

In this case, the control program stored in the second flash ROM 24 is assigned to the CS0 area of the CPU 21 and executed. “YES” is judged in Step S2. A download process is performed by the execution of the control program. In the download process, the control program stored in the second flash ROM 24 is written in the first flash ROM 22 through the CPU 21 (Step S4).

Thus, the control program which is stored in the second flash ROM 24 mounted on the download board 12 can become the same control program stored in the first flash ROM 22.

Then, a standby state is held until the power switch 21 is turned off. The down load board 12 is removed from the socket 23 after the power switch 25 is turned off.

When the power switch 21 is turned on again, the CPU 21 reads the control program stored in the first flash ROM 22 mounted on the target system board 11, and the CPU 21 executes the control program.

The embodiment of the invention can be applied to a system shown in FIG. 5. That is, the CPU mounted on an MFP (Multi Function Peripheral) main body 71 or the CPU mounted on a finisher 72 connected to the MFP main body 71 can include the program which performs the process of the flowchart of FIG. 4.

It is also possible that the CPU 21 is connected to a display unit which indicates that the control program is downloaded from the second flash ROM 24 mounted on the download board 12.

In the embodiment, the CONNECT terminal is set to the ground (L-level) when the download board 12 is inserted into the socket 23. However, when the CONNECT terminal is formed so as not to be set to the ground (L-level) even if a board is inserted into the socket 23, an extension board can also be inserted into the socket 23.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A computer apparatus on which a download board can be mounted, comprising:
a first flash ROM which stores a control program;
a CPU which executes the control program;
a socket which the download board can be inserted into and removed from, a second flash ROM being mounted on the download board, the control program being stored in the second flash ROM;
a system board on which the socket is mounted;
a signal generating unit configured to output a connect signal having a specific logic level when the download board is connected to the socket; and
a switching circuit configured to switch a signal for specifying a sector CS0 area of the CPU and a signal for specifying a sector CS1 area of the CPU according to a status of the connect signal, the signal for specifying the sector CS0 area being output from the CPU according to the connect signal output from the signal generating unit, the sector CS0 area being used for a boot,
wherein, when the CPU senses the connect signal output from the signal generating unit to detect connection between the download board and the socket, the CPU assigns the control program, which is specified by the signal for specifying the sector CS0 area output from the switching circuit and stored in the second flash ROM, to the sector CS0 area of the CPU to execute the control program, and the CPU downloads the control program stored in the second flash ROM to the first flash ROM.

2. A computer apparatus according to claim 1, further comprising a display unit,
wherein, when the download is ended, the end of the download is displayed on the display unit.

3. A computer apparatus according to claim 1, wherein the system board is the board which is mounted on an image forming apparatus.

4. A computer apparatus on which a download board can be mounted, comprising:
a first flash ROM which stores a control program;
a CPU which executes the control program;
a socket which the download board can be inserted into and removed from, a second flash ROM being mounted on the download board, the control program being stored in the second flash ROM;
a system board on which the socket is mounted;
signal generating means for outputting a connect signal having a specific logic level when the download board is connected to the socket; and
switching means for switching a signal for specifying a sector CS0 area of the CPU and a signal for specifying a sector CS1 area of the CPU according to a status of the connect signal, the signal for specifying the sector CS0 area being output from the CPU according to the connect signal output from the signal generating means, the sector CS0 area being used for a boot,
wherein, when the CPU senses the connect signal output from the signal generating means to detect connection between the download board and the socket, the CPU assigns the control program, which is specified by the signal for specifying the sector CS0 area output from the switching means and stored in the second flash ROM, to the sector CS0 area of the CPU to execute the control program, and the CPU downloads the control program stored in the second flash ROM to the first flash ROM.

5. A computer apparatus according to claim 4, further comprising a display unit,
wherein, when the download is ended, the end of the download is displayed on the display unit.

6. A computer apparatus according to claim 4, wherein the system board is the board which is mounted on an image forming apparatus.
